(19) United States
(12) Patent Application Publication
(10) Pub. No.: US 2007/0126931 A1
(43) Pub. Date: Jun. 7, 2007

(54) Method and video apparatus for auto-compensating weak signals

(75) Inventor: Kuen-Jen Hung, Taoyuan City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/602,313

(22) Filed: Nov. 21, 2006

(30) Foreign Application Priority Data
Dec. 5, 2005 (TW) 94142834

(51) Int. Cl. H04N 5/50; H04N 5/00

(52) U.S. Cl. 348/570; 348/731; 348/607

(57) ABSTRACT

A video apparatus and method for auto-compensating weak signals are disclosed. The video apparatus includes a tuner, video decoder and controller. The turner receives an analog signal and accordingly outputs a video signal, and generates a gain control signal according to intensity of the analog signal. The video decoder decodes the video signal to be a digital signal. The controller receives the digital signal and gain control signal and outputs an image according to the digital signal. When the controller determines that the analog signal is a weak signal according to the gain control signal, a noise reduction function of the video decoder is actuated to generate the digital signal. The controller displays a message on a monitor according to the gain control signal, which represents intensity of the analog signal, for the user as a basis of troubleshooting.

This application claims the benefit of Taiwan application Ser. No. 94142834, filed Dec. 05, 2005, the subject matter of which is incorporated herein by reference.

### BACKGROUND OF THE INVENTION

1. Field of the Invention

The invention relates in general to a video apparatus, and more particularly to a method and video apparatus for auto-compensating weak signals.

2. Description of the Related Art

In image display of a conventional analog TV, a TV tuner receives electrical waves via antenna, converts the electrical waves to video signals, and transmits the video signals to a controller for signal processing to generate images. When the electrical-wave signal becomes weak due to environmental variation, the corresponding video signal will also decrease in intensity accompanied with noise. In order to solve the issue, traditionally, the user estimates signal intensity by the naked eye and actuates a control interface to provide a noise reduction function for improving image quality by hand.

However, it is not accurate to determine signal intensity by the naked eye. Besides, for some televisions, in order to reduce noise, the user usually needs to open a functional frame via a control interface, browse function items to look for the noise reduction function and select the corresponding function item by cursor to actuate that function, which causes great inconvenience in operation.

### SUMMARY OF THE INVENTION

It is therefore an object of the invention to provide a method for auto-compensating weak signals.

The invention achieves the above-identified object by providing a video apparatus for auto-compensating weak signals including a tuner, controller, and video decoder. The turner is for receiving an analog signal and accordingly outputting a video signal, and generating an auto gain control signal according to intensity of the analog signal. The controller is for receiving the auto gain control signal to determine the intensity of the analog signal, and generating a control signal. The video decoder is for receiving the video signal and the control signal, and decoding the video signal to be a digital signal.

The invention achieves the above-identified object by providing a method for auto-compensating weak signals applied to a video apparatus including a turner, a video decoder and a controller. The method includes receiving an analog signal and outputting a video signal and an auto gain control signal represents intensity of the analog signal by the tuner; receiving the gain control signal and accordingly determining the intensity of the analog signal, and generating a control signal by the controller; and decoding the video signal and receiving the control signal to accordingly generate a digital signal by the video decoder.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a video apparatus for auto-compensating weak signals according to a preferred embodiment of the invention.

FIG. 2 is a block diagram of a video apparatus for auto-compensating weak signals according to another preferred embodiment of the invention.

FIG. 3 is a schematic diagram of display content of the monitor-in FIG. 2.

FIG. 4 is a flow chart of a method for auto-compensating weak signals according to a preferred embodiment of the invention.

FIG. 5 is a table of relationship between voltage values of the auto gain control signal AGC and analog signal AS.

### DETAILED DESCRIPTION OF THE INVENTION

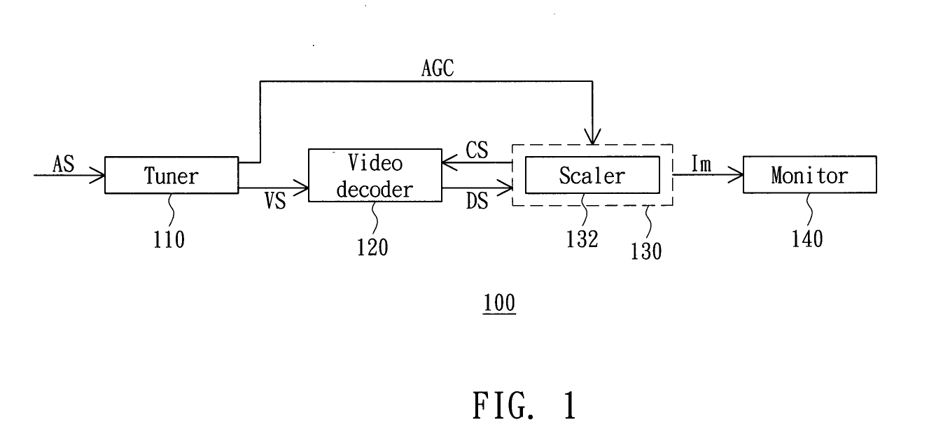

Referring to FIG. 1, a block diagram of a video apparatus for auto-compensating weak signals according to a preferred embodiment of the invention is shown. A video apparatus 100 includes a tuner 110, video decoder 120, controller 130 and monitor 140. The controller includes a scaler 132 for instance. The tuner 110 is for receiving an analog signal AS, accordingly outputting a video signal VS, such as a composite video broadcast signal (CVBS), and generating an auto gain control signal AGC according to intensity of the analog signal AS. The video decoder 120 receives the video signal VS from the tuner 110 and converts the video signal VS to a digital signal DS, such as with an ITU-656 signal format. The controller 130 receives the auto gain control signal AGC and accordingly outputs a control signal CS to control the video decoder 120. The controller 130 also receives the digital signal DS and accordingly outputs an image Im, such as with an R/G/B format. The scaler 132 is for adjusting resolution of the digital signal DS, for example, changing from 640×480 to 800×600 and displaying the resolution on the monitor 140.

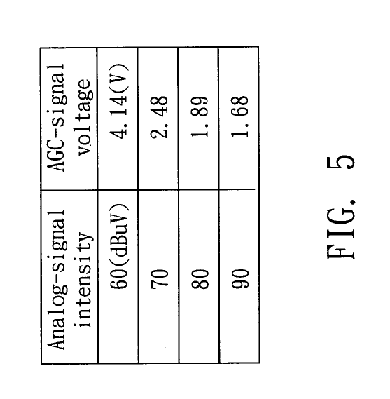

Referring to FIG. 5, a table of relationship between voltage values of the auto gain control signal AGC and analog signal AS is shown. When the analog AS becomes stronger, the voltage value of the auto gain control signal AGC generated by the tuner 110 becomes smaller, while when the analog signal AS becomes weaker, the auto gain control signal AGC of the turner 110 has a larger voltage value.

The controller 130 can determine intensity of the present analog signal AS according to the voltage value of the AGC signal, and then output the control signal CS to decide whether to control the video decoder 120 to actuate noise reduction function. When the analog signal AS becomes very weak, such as with intensity of 60 dBuV, the tuner 110 outputs a larger voltage (4.14V) of the auto gain control signal AGC. Therefore, the controller 130 can accordingly control the video decoder 120 to actuate the noise reduction function to generate the digital signal DS of low noise. Furthermore, the controller 130 can control the video decoder 120 to actuate the noise reduction function in different extent according to intensity of the auto gain control signal AGC. For example, in FIG. 5, when the AGC signal has a voltage value 1.89V, the video decoder 120 actuates the first-class noise reduction function, while when the AGC signal has a voltage value rising up to 4.14V, the second-class noise function is actuated to perform larger signal compensation.

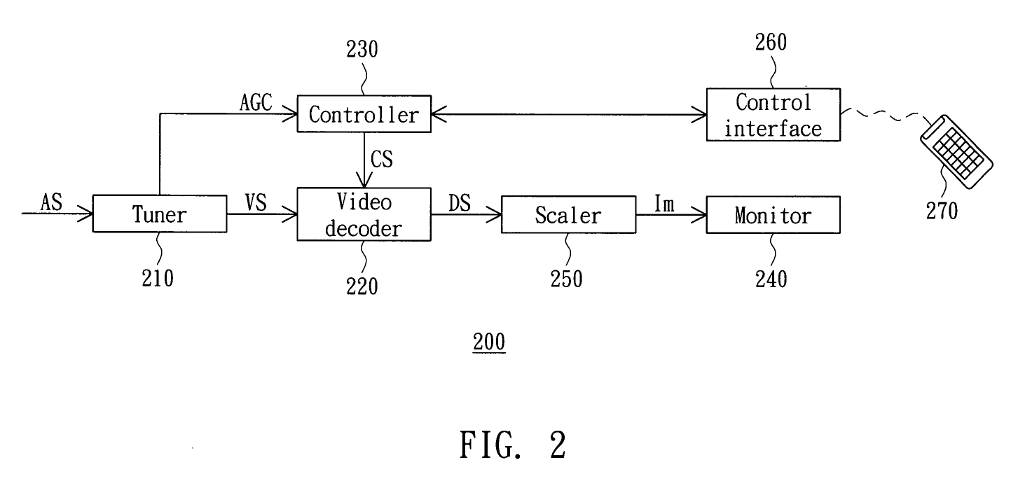

Referring to FIG. 2, a block diagram of a video apparatus for auto-compensating weak signals according to another preferred embodiment of the invention is shown. A video apparatus 200 includes a turner 210, video decoder 220, controller 230, monitor 240, scaler 250, control interface 260 and remoter 270. In the embodiment, the controller 230 and scaler 250 are independently disposed in a chip of a mainboard (not shown in the figure) of the video apparatus 200. The scaler 250 receives the digital DS and accordingly outputs an image Im. The controller 230 receives an auto gain control signal AGC to determine intensity of the analog signal AS and accordingly outputs a control signal CS to control the video decoder to actuate a noise reduction function. The control interface 260 is for the user to operate the video apparatus by a touch pad or remoter. In the embodiment, the video apparatus 200 is operated via the remoter 270. When the user actuates a signal state function of the video apparatus 200 via the remoter 270, the controller 230 displays a message on the monitor 240 to notify the user about the signal intensity according to the auto gain control signal AGC.

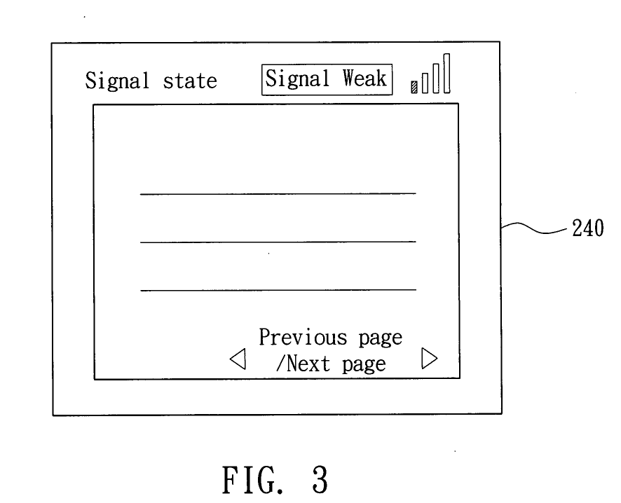

Referring to FIG. 3, a schematic diagram of display content of the monitor 240 in FIG. 2 is shown. When the user actuates the signal state function via the remoter 270, the monitor 240 displays a message representing intensity of the analog signal AS, such as the words ‘Signal Weak’ and the user can make troubleshooting accordingly. When the user determines that image noise is too large, he/she can actuate the signal state function to find out whether the noise is generated due to too small intensity of the signal or other situations, such as poor contact between connectors.

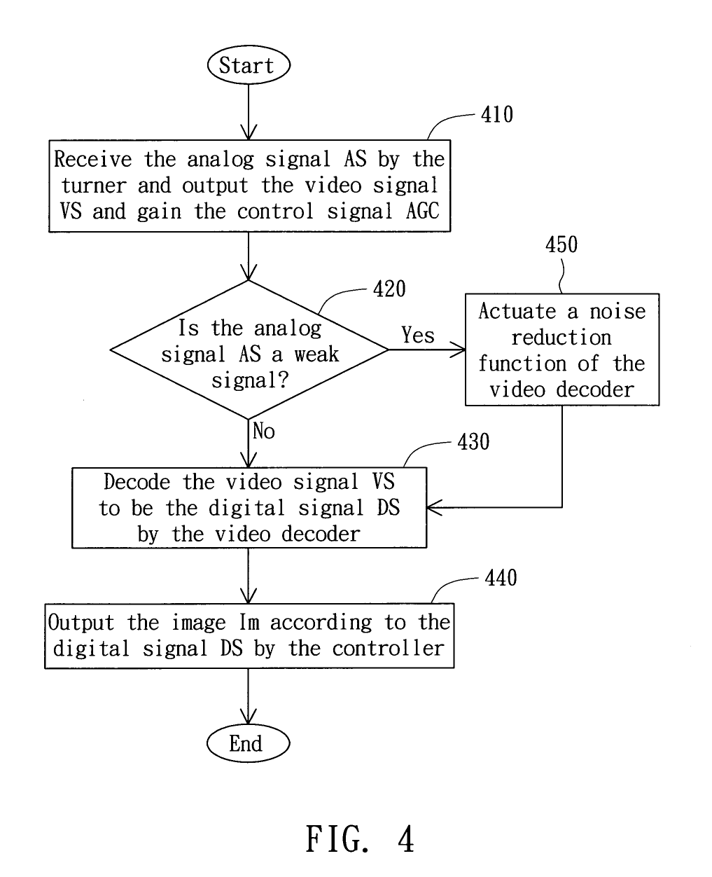

Referring to FIG. 4, a flow chart of a method for auto-compensating weak signals according to a preferred embodiment of the invention is shown. First, in step 410, receive the analog signal AS by the turner 110 and output the video signal VS and auto gain control signal AGC. Following that, in step 420, determine whether the analog signal AS is a weak signal. If the analog signal AS is not a weak signal, perform the step 430 to decode the video signal VS to be the digital signal DS by using the video decoder 120. Next, in step 440, output the image Im according to the digital signal DS by using the controller 130. If the controller 130 determine that the analog signal AS is a weak signal according to the voltage value of the auto gain control signal AGC in the step 420, the step 450 is performed before the step 440 to actuate the noise reduction function of the video decoder.

In order to provide the user with information about the analog signal AS, the method further includes a step for determining whether the signal state function is actuated by the user. If yes, the corresponding message is displayed on the monitor according to the auto gain control signal to notify the user about intensity of the analog signal.

The video apparatus and method for auto-compensating weak signals disclosed by the above-mentioned embodiment of the invention can determine whether the analog signal As is a weak signal according to the gain control signal AGC and then perform an auto-signal compensation to effectively reduce the image noise occurred due to a weak signal. Through the auto-compensation, the video apparatus improve convenience in usage. Besides, the user can actuate the signal state function via the control interface to obtain signal state related information as a basis for making troubleshooting.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video apparatus for auto-compensating weak signals, comprising:
a turner, for receiving an analog signal and accordingly outputting a video signal, and generating a gain control signal according to intensity of the analog signal;
a controller, for receiving the gain control signal to determine the intensity of the analog signal, and generating a control signal; and
a video decoder, for receiving the video signal and the control signal, and decoding the video signal to be a digital signal.

2. The apparatus according to claim 1, wherein when the controller determines that the analog signal is a weak signal, the controller outputs the control signal for actuating a noise reduction function of the video decoder to generate the digital signal.

3. The apparatus according to claim 2, wherein the controller comprises a scaler for adjusting resolution of the digital signal.

4. The apparatus according to claim 1, further comprising a monitor for displaying an image according to the digital signal.

5. The apparatus according to claim 4, wherein the controller displays a message on the monitor according to the gain control signal and the message represents the intensity of the analog signal.

6. The apparatus according to claim 5, wherein the message is provided to a user for a basis of troubleshooting.

7. A method for auto-compensating weak signals, applied to a video apparatus comprising a turner, a video decoder and a controller, the method comprising:
(a) receiving an analog signal and outputting a video signal and a gain control signal represents intensity of the analog signal by the tuner;
(b) receiving the gain control signal and accordingly determining the intensity of the analog signal, and generating a control signal by the controller; and
(c) decoding the video signal and receiving the control signal to accordingly generate a digital signal by the video decoder.

8. The method according to claim 7, wherein the video apparatus comprises a monitor, and the method further comprises:
displaying a message on the monitor according to the gain control signal, wherein the message represents the intensity of the analog signal.

9. The method according to claim 7, wherein the controller determines if a noise reduction function of the video decoder is actuated to generate the digital signal.
